(19) United States
(12) Patent Application Publication
(10) Pub. No.: US 2007/0057400 A1
(43) Pub. Date: Mar. 15, 2007

(54) Polycarbonate useful in making solvent cast films

(75) Inventors: Edward Kung, Bergen op Zoom (NL); Hans Looij, Bergen op Zoom (NL); Brian D. Mullen, Mt. Vernon, IN (US)

Correspondence Address: GEAM - LEXAN;IP LEGAL, ONE PLASTICS AVE., PITTSFIELD, MA, 01201-3697, US

(73) Assignee: General Electric Company, Schenectady, NY (US)

(21) Appl. No.: 11/223,519

(22) Filed: Sep. 9, 2005

(51) Int. Cl. B29C 39/14

(52) U.S. Cl. 264/141; 264/216; 264/211.24; 528/196

(57) ABSTRACT

A method for making high quality films from polycarbonate resins is described. The method involves the steps of making and isolating a polycarbonate resin using an activated carbonate melt polymerization process; forming a solution of the polycarbonate resin in an organic solvent, solvent casting the polycarbonate resin solution and then removing the organic solvent in a controlled manner to form a polycarbonate resin film. The use of these films in various applications is also described.

### BACKGROUND OF INVENTION

This application relates to films formed from polycarbonate resins, methods to make these films, and uses of these films.

Polycarbonate resins have found wide use in consumer items, the automotive industry, medical industry and the building and construction industry as well as many other markets, because of their high heat and impact resistance, and their ability to form very useful blends with other resins. A very highly desirable property of many polycarbonate resins is their transparency, which, in combination with their heat resistance and high impact resistance, allows them to replace glass or other transparent thermoplastics in many consumer markets such as the ophthalmic lens, the optical media, the medical and the building and construction markets.

A particularly high-growth opportunity for polycarbonate resins is in thermoplastic films. Films formed from polycarbonate resins are useful in many applications and examples include: light filters, electrical capacitors, optical media systems, optical displays, and photoreceptor systems. Many of these applications require light to pass through the polycarbonate film with little or no distortion or any substantial reduction in intensity. To achieve these requirements, the polycarbonate film must be substantially free of any particulates, resin degradation products, or residual optical stresses. Residual optical stresses are essentially inhomogeneous regions of the film caused by subjecting a transparent thermoplastic film to physical tension when it is still at a relatively high temperature and then cooling it fast enough such that the inhomogenous regions caused by the tension differentials are “frozen into” the structure of the film as it cools. This problem typically happens when films are made by common continuous production methods involving passing them through high tension rollers, which can apply uneven shear tension to the surface of a film versus the inside of a film or another side of a film. The tension causes some optical inhomogeneity that will slightly affect light as it passes through the film, causing visual abnormalities that are unacceptable for some uses. One of the most successful means of minimizing optical stresses is by employing a solvent casting process to form the film. A conventional solvent casting process involves dissolving a polycarbonate resin in an organic solvent, in which it is very soluble, filtering the polycarbonate resin solution one or more times, and forming a film by casting the filtered solution onto a film forming apparatus and then slowly evaporating the solvent under highly controlled conditions. Under such conditions, there are no rollers or rapid cooling that can contribute to optical stresses.

A particular challenge with solvent casting of polycarbonate films is the tendency of polycarbonate resins to crystallize in the solvent before or during the casting process. Crystallized polycarbonate resin in the cast films can cause a loss of film transparency and even can cause film brittleness. Melting of the crystallized polycarbonate resin requires very high temperatures, which can lead to degradation of the polycarbonate resin and further loss of optical and mechanical properties.

Several approaches have been developed to reduce the tendency of a polycarbonate resin to crystallize during the film casting process. They include adjusting the solvent evaporation conditions, changing the type of solvent used, and using a co-polycarbonate resin containing sufficient quantities of a second or even a third monomer to prevent crystallization. Each of these methods has disadvantages such as operational complexity, high resin and solvent costs, and low manufacturing productivity. A preferred solution to produce high quality polycarbonate films would involve developing a method to form a polycarbonate resin that results in a resin with a reduced tendency to crystallize during solvent casting and using these polycarbonate resins in a solvent casting process.

### BRIEF DESCRIPTION OF THE INVENTION

The present invention relates to films formed from polycarbonate resins that have a low tendency to crystallize during a solvent casting process, methods for making these films, and uses of these films.

In one aspect of the invention, a method for making a polycarbonate resin film is described that comprises the steps of making and isolating a polycarbonate resin using an activated carbonate melt process, forming a solvent-mixture, and casting a polycarbonate film from the solvent-mixture.

In another aspect of the invention, a method is described which further includes making pellets of the polycarbonate resin using the activated carbonate method described above, before the step of forming the solvent-mixture.

In still another aspect of the invention, a polycarbonate film is made using the methods described above. The film has a haze of less than 3%.

In still another aspect of the invention, a polycarbonate film is made using the methods described above. The film has a haze of less than 1%.

In yet another aspect of the invention, the polycarbonate film, made using the methods described above, is used as a capacitor film or as a photoreceptor film.

### BRIEF DESCRIPTION OF THE DRAWINGS

Referring now to the following Figure in which:

FIG. 1 is a Table that compares the haze and quality of solvent cast films formed from polycarbonate resins that were made using three different synthesis methods. Examples 1 to 6 were made using an activated carbonate melt synthesis method and employing the activated carbonate, bis(methylsalicyl)carbonate (BMSC). Comparative Examples 1, 3, 4, and 6 were made using an interfacial synthesis method. Comparative Examples 2, 5 and 7 were made using a melt synthesis method but without employing the activated carbonate method and employing diphenylcarbonate.

### DETAILED DESCRIPTION OF PREFERRED EMBODIMENTS

It has been surprisingly found that highly transparent polycarbonate films can be made from a solvent casting process employing polycarbonate resins that are made using an activated carbonate melt process. The transparent films from the method of the present invention have typical transmission haze values of less than 3 as measured with a hazemeter according to the ASTM D1003 standardized test method. While applicants do not wish the invention to be bound by any particular theory of operation, it is believed that the activated carbonate melt process probably results in chemical structures in the polycarbonate resin that possess a low tendency to crystallize during the solvent casting process resulting in films that have low haze values.

The present invention may be understood more readily by reference to the following detailed description of preferred embodiments of the invention and the examples included therein. In the following specification and the claims which follow, reference will be made to a number of terms which shall be defined to have the following meanings:

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

A polycarbonate resin with a “tendency to crystallize” is defined herein to be one that is characterized by the appearance of haze in a solution of the polycarbonate resin with an organic solvent or in a film cast from the polycarbonate resin solution after using a solvent casting process. Any polycarbonate that has a tendency to crystallize from an organic solvent before or during the casting process and that can be produced using a melt polymerization method, would be expected to be suitable in the process of the present invention.

Polycarbonates of the present invention are prepared using melt polymerization reaction conditions involving an aromatic dihydroxy compound and an activated diaryl carbonate in the presence of a polymerization catalyst. The polymerization catalyst can be one or a combination of basic catalysts.

Suitable aromatic polycarbonates can possess recurring structural units of the formula (I): 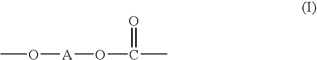
wherein A is a divalent aromatic radical of an aromatic dihydroxy compound employed in the polymer reaction.

The aromatic dihydroxy compound that can be used to form aromatic carbonate polymers, are mononuclear or polynuclear aromatic compounds, containing as functional groups two hydroxy radicals, each of which can be attached directly to a carbon atom of an aromatic nucleus. Suitable dihydroxy compounds are, for example, resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,1-bis(4-hydroxyphenyl)methane, 1,1-bis(4-hydroxyphenyl)ethane, 1,2-bis(4-hydroxyphenyl)ethane, 1,1-bis(4-hydroxyphenyl)-1-phenylethane, 2,2-bis(4-hydroxyphenyl)propane (“bisphenol A”), 2-(4-hydroxyphenyl)-2-(3-hydroxyphenyl)propane 2,2-bis(4-hydroxyphenyl)butane, 2,2-bis(4-hydroxyphenyl) octane, 1,1-bis(4-hydroxyphenyl)propane, 1,1-bis(4-hydroxyphenyl)n-butane, bis(4-hydroxyphenyl)phenylmethane, 2,2-bis(4-hydroxy-1-methylphenyl)propane, 1,1-bis(4-hydroxy-tert-butylphenyl)propane, 2,2-bis(4-hydroxy-3-bromophenyl)propane, and 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, alpha.alpha.′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, 2,7-dihydroxycarbazole and the like, as well as combinations and reaction products comprising at least one of the foregoing dihydroxy compounds.

In various embodiments, two or more different aromatic dihydroxy compounds or a copolymer of an aromatic dihydroxy compound with an aliphatic diol, with a hydroxy- or acid-terminated polyester or with a dibasic acid or hydroxy acid can be employed in the event a carbonate copolymer or interpolymer is desired.

The method of the present invention utilizes a melt polycarbonate synthesis method that employs an activated diaryl carbonate. As used herein the term “activated carbonate process” is one that utilizes a melt polycarbonate synthesis method (“melt” meaning a method that relies on reacting the aromatic dihydroxy compound and the carbonate compound together at a sufficiently high temperature such that the mixture is molten in the substantial absence of a solvent) employing an activated diaryl carbonate. As used herein the term “activated diaryl carbonate” is defined as a diaryl carbonate that is more reactive than diphenylcarbonate toward transesterification reactions. Such diaryl carbonates typically have the formula (II): 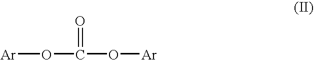
wherein Ar is a substituted aromatic radical having 6 to 30 carbon atoms. Activated diaryl carbonates have the more specific general formula (III): 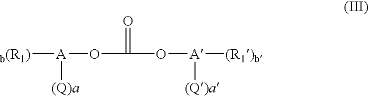
wherein Q and Q′ are each independently an ortho-positioned activating group. A and A′ are each independently aromatic rings which can be the same or different depending on the number and location of their substituent groups, and a and a′ are whole numbers of zero up to a maximum equivalent to the number of replaceable hydrogen groups substituted on the aromatic rings A and A′ respectively, wherein a+a′ is greater than or equal to 1. R₁ and R₁′ are each independently substituent groups such as alkyl, cycloalkyl, alkoxy, aryl, alkylaryl, cyano, nitro, or halogen. The number b is a whole number of from zero up to a maximum equivalent to the number of replaceable hydrogen atoms on the aromatic ring A minus the number a, and the number b′ is a whole number of from zero up to a maximum equivalent to the number of replaceable hydrogen atoms on the aromatic ring A′ minus the number a′. The number, type and location of the R₁ or R₁′ substituents on the aromatic ring is not limited unless they deactivate the diaryl carbonate and lead to a diaryl carbonate which is less reactive than diphenyl carbonate.

Non-limiting examples of suitable ortho-positioned activating groups Q and Q′ include (alkoxycarbonyl)aryl groups, halogens, nitro groups, amide groups, sulfone groups, sulfoxide groups, or imine groups with structures indicated below: 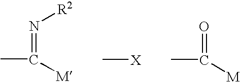
wherein X is halogen or NO₂; M and M′ independently comprises N-dialkyl, N-alkylaryl, alkyl or aryl; and R2 is alkyl or aryl. Specific and non-limiting examples of activated carbonates include bis(o-methoxycarbonylphenyl)carbonate, bis(o-chlorophenyl)carbonate, bis(o-nitrophenyl)carbonate, bis(o-acetylphenyl)carbonate, bis(o-phenylketonephenyl)carbonate, bis(o-formylphenyl)carbonate. Unsymmetrical combinations of these structures, where the substitution number and type on A and A′ are different, are also possible to employ in the current invention. One structural embodiment for an activated carbonate is an ester-substituted diaryl carbonate having the structure (IV): 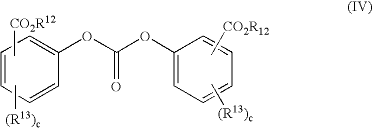
wherein R¹² is independently at each occurrence a C₁-C₂₀ alkyl radical, C₄-C₂₀ cycloalkyl radical, or C₄-C₂₀ aromatic radical; R¹³ is independently at each occurrence a halogen atom, cyano group, nitro group, C₁-C₂₀ alkyl radical, C₄-C₂₀ cycloalkyl radical, C₄-C₂₀ aromatic radical, C₁-C₂₀ alkoxy radical, C₄-C₂₀ cycloalkoxy radical, C₄-C₂₀ aryloxy radical, C₁-C₂₀ alkylthio radical, C₄-C₂₀ cycloalkylthio radical, C₄-C₂₀ arylthio radical, C₁-C₂₀ alkylsulfinyl radical, C₄-C₂₀ cycloalkylsulfinyl radical, C₄-C₂₀ arylsulfinyl radical, C₁-C₂₀ alkylsulfonyl radical, C₄-C₂₀ cycloalkylsulfonyl radical, C₄-C₂₀ arylsulfonyl radical, C₁-C₂₀ alkoxycarbonyl radical, C₄-C₂₀ cycloalkoxycarbonyl radical, C₄-C₂₀ aryloxycarbonyl radical, C₂-C₆₀ alkylamino radical, C₆-C₆₀ cycloalkylamino radical, C₅-C₆₀ arylamino radical, C₁-C₄₀ alkylaminocarbonyl radical, C₄-C₄₀ cycloalkylaminocarbonyl radical, C₄-C₄₀ arylaminocarbonyl radical, or C₁-C₂₀ acylamino radical; and c is independently at each occurrence an integer 0-4. At least one of the substituents CO₂R¹² is preferably attached in an ortho position of formula (IV).

Examples of ester-substituted diaryl carbonates include but are not limited to bis(methylsalicyl)carbonate (CAS Registry No. 82091-12-1) also known as BMSC also known as bis(o-methoxycarbonylphenyl)carbonate, bis(ethyl salicyl)carbonate, bis(propyl salicyl)carbonate, bis(butylsalicyl)carbonate, bis(benzyl salicyl)carbonate, bis(methyl 4-chlorosalicyl)carbonate and the like. One commonly used activated carbonate is bis(methylsalicyl)carbonate due to its low molecular weight and high vapor pressure.

Some non-limiting examples of groups that when present in the ortho position of a diaryl carbonate would not be expected to result in activated diaryl carbonates include hydrogen, alkyl, cycolalkyl or cyano groups. As used herein the term “non-activated diaryl carbonates” refers to diaryl carbonates that are as reactive or less reactive than diphenyl carbonate. Some specific and non-limiting examples of non-activated carbonates are bis(o-methylphenyl)carbonate, bis(p-cumylphenyl)carbonate, bis(p-(1,1,3,3-tetramethyl)butylphenyl)carbonate and bis(o-cyanophenyl)carbonate. Unsymmetrical combinations of these structures are also expected to result in non-activated carbonates.

Unsymmetrical diaryl carbonates wherein one aryl group is activated and one aryl is inactivated would also useful in this invention if the activating group renders the diaryl carbonate more reactive than diphenyl carbonate.

One method for determining whether a certain diaryl carbonate is activated or is not activated in a melt polymerization process is to carry out a model transesterification reaction between the certain diaryl carbonate and a phenol such as p-(1,1,3,3-tetramethyl)butyl phenol and then to compare the relative reactivity of the certain diaryl carbonate versus diphenyl carbonate. The phenol, p-(1,1,3,3-tetramethyl)butyl phenol, is often used to compare the relative reactivity of diaryl carbonates because it possesses only one reactive site, possesses a low volatility and possesses a similar reactivity to bisphenol-A.

The model transesterification reaction is conducted in the presence of a transesterification catalyst, which is usually an aqueous solution of sodium hydroxide or sodium phenoxide, but any known transesterification catalyst could be used for the comparison. A useful concentration of the transesterification catalyst is about 0.001 mole % based on the number of moles of the diaryl carbonate. The model transesterification reaction is carried out at temperatures above the melting point of the certain diaryl carbonate. One useful reaction temperature is 200° C. Sealed tubes can be used if the reaction temperatures cause the reactants to volatilize and affect the reactant molar balance. The determination of the equilibrium concentration of reactants is accomplished through reaction sampling during the course of the reaction and then analysis of the reaction mixture using a well-know detection method to those skilled in the art such as HPLC (high pressure liquid chromatography). Particular care needs to be taken so that reaction does not continue after the sample has been removed from the reaction vessel. This is accomplished by cooling down the sample in an ice bath and by employing a reaction quenching acid such as acetic acid in the water phase of the HPLC solvent system. It may also be desirable to introduce a reaction quenching acid directly into the reaction sample in addition to cooling the reaction mixture. One possible concentration commonly used for the acetic acid in the water phase of the HPLC solvent system is 0.05 mole %. The equilibrium constant is determined from the concentration of the reactants and product when equilibrium is reached. Equilibrium is assumed to be reached when the concentration of components in the reaction mixture reaches a point of little or no change on sampling of the reaction mixture. The equilibrium constant can be determined from the concentration of the reactants and products at equilibrium by methods well known to those skilled in the art. A diaryl carbonate, which possesses a relative equilibrium constant (K diarylcarbonate/K diphenylcarbonate) of greater than 1, is considered to possess a greater reactivity than diphenyl carbonate and is an activated carbonate, whereas a diaryl carbonate which possesses an equilibrium constant of 1 or less is considered to possess the same or lesser reactivity than diphenyl carbonate and is considered not to be activated. Employing an activated diaryl carbonate with a very high reactivity compared to diphenyl carbonate (for example, 1000 times greater than diphenyl carbonate or more) is often desirable in conducting melt polycarbonate polymerization reactions.

Advantageous catalysts commonly known for use in polycarbonate melt reactions may be used in melt reactions involving activated carbonates. Some commonly known melt polymerization catalysts include alkali metal salts, or alkali earth metal salts of organic and inorganic acids, quaternary ammonium salts of organic or inorganic acids, or quaternary phosphonium salts of inorganic or organic acids, and mixtures thereof. It is often advantageous to combine a salt of an alkali earth metal or an alkali metal of an inorganic or organic acid, with a quaternary ammonium or a quaternary phosphonium salt of an inorganic or organic acid. The total amount of catalyst employed is often about 1×10⁻⁷ to about 1×10⁻², and also commonly about 1×10⁻⁷ to about 1×10⁻³ moles catalyst per total moles of the mixture of aromatic dihydroxy compound.

Exemplary quaternary ammonium compounds include compounds comprising structure (V) 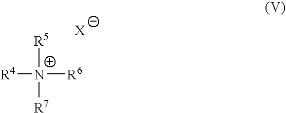
wherein R⁴-R⁷ are independently a C₁-C₂₀ alkyl radical, C₄-C₂₀ cycloalkyl radical or a C₄-C₂₀ aryl radical and X⁻ is an organic or inorganic anion as previously. Suitable anions X⁻ include hydroxide, halide, carboxylate, sulfonate, sulfate, carbonate and bicarbonate. In one embodiment, the transesterification catalyst comprises tetramethyl ammonium hydroxide (TMAH).

Exemplary quaternary phosphonium compounds include compounds comprising structure (VI) 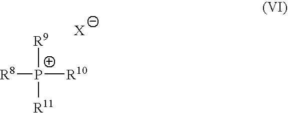
wherein R⁸-R¹¹ are independently a C₁-C₂₀ alkyl radical, C₄-C₂₀ cycloalkyl radical or a C₄-C₂₀ aryl radical and X⁻ is an organic or inorganic anion as previously described. Where X⁻ is a polyvalent anion such as carbonate or sulfate it is understood that the positive and negative charges in structures VI and VII are properly balanced.

In one embodiment, the catalyst comprises tetrabutyl phosphonium acetate. In an alternate embodiment, the catalyst comprises a mixture of an alkali metal salt or alkaline earth metal salt with at least one quaternary ammonium compound, at least one quaternary phosphonium compound, or a mixture thereof, for example a mixture of sodium hydroxide and tetrabutyl phosphonium acetate. In another embodiment the catalyst is a mixture of sodium hydroxide and tetramethyl ammonium hydroxide.

In one embodiment, the catalyst is an alkaline earth metal hydroxide, an alkali metal hydroxide or a mixture thereof. Suitable alkali earth and alkali metal hydroxides are illustrated by calcium hydroxide, magnesium hydroxide, sodium hydroxide, potassium hydroxide and lithium hydroxide.

In another embodiment, the catalyst comprises an alkali earth metal salt of an organic acid, an alkali metal salt of an organic acid, or a salt of an organic acid comprising both alkali earth metal ions and alkali metal ions. Salts of organic acids useful as catalysts are illustrated by alkali metal and alkaline earth metal salts of formic acid, acetic acid, stearic acid and ethyelenediamine tetraacetic acid. In one embodiment the catalyst comprises magnesium disodium ethylenediamine tetraacetate.

In yet another embodiment, the catalyst comprises the salt of a non-volatile inorganic acid. By “nonvolatile” it is meant that the referenced compounds have no appreciable vapor pressure at ambient temperature and pressure. In particular, these compounds are not volatile at temperatures at which melt polymerizations of polycarbonate are typically conducted. The salts of nonvolatile acids are alkali metal salts of phosphites; alkaline earth metal salts of phosphites; alkali metal salts of phosphates; and alkaline earth metal salts of phosphates. Suitable salts of nonvolatile acids include NaH₂PO₃, NaH₂PO₄, Na₂H₂PO₃, KH₂PO₄, CsH₂PO₄, Cs₂H₂PO₄, or a mixture thereof. In one embodiment, the transesterification catalyst comprises both the salt of a non-volatile acid and a basic co-catalyst such as an alkali metal hydroxide. This concept is exemplified by the use of a combination of NaH₂PO₄ and sodium hydroxide as the transesterification catalyst.

The reactants for the polycarbonate melt polymerization reaction can be charged into the reactor in a solid form, in a melted form or in an inorganic or organic solvent mixture. Initial charging of reactants into a reactor and subsequent mixing of these materials under reactive conditions for polymerization may be conducted in an inert gas atmosphere such as a nitrogen atmosphere. Additional charging of one or more reactants may also be done at a later stage of the polymerization reaction. Mixing of the reaction mixture is accomplished by any methods known in the art, such as using a stirrer in a melt reactor or using a mixing screw in an extruder. Typically the activated aromatic carbonate is added at a mole ratio at about 0.8 to about 1.3 and more specifically 0.9 to about 1.1 and all subranges there between, relative to the total moles of aromatic dihydroxy compound.

The polycarbonate is formed by subjecting the above reaction mixture to one or more of a series of temperature-pressure-time protocols. In some embodiments, this involves gradually raising the reaction temperature in stages while gradually lowering the pressure in stages. In one embodiment, the pressure is reduced from about atmospheric pressure at the start of the reaction to about 0.01 millibar (1 Pa) or in another embodiment to 0.05 millibar (5 Pa) in several steps as the reaction approaches completion. The temperature may be varied in a stepwise fashion beginning at a temperature of about the melting temperature of the reaction mixture and subsequently increased to about 320° C. In one embodiment, the reaction mixture is heated from room temperature to about 150° C. The polymerization reaction starts at a temperature of about 150° C. to about 220° C., then is increased to about 220° C. to about 250° C. and is then further increased to a temperature of about 250° C. to about 320° C. and all subranges there between. The total reaction time is about 30 minutes to about 200 minutes and all subranges there between. This procedure will generally ensure that the reactants react to give polycarbonates with the desired molecular weight, glass transition temperature and physical properties. The reaction proceeds to build the polycarbonate chain with production of ester-substituted alcohol by-product (such as methyl salicylate when bis(methylsalicyl)carbonate is employed). Efficient removal of the by-product may be achieved by different techniques such as reducing the pressure. Generally, the pressure is high in the beginning of the reaction and is lowered progressively throughout the reaction while the temperature is raised throughout the reaction. Experimentation is sometimes needed to find the most efficient conditions for forming a polycarbonate using a particular activated diaryl carbonate and a particular bisphenol or combination of bisphenols.

The progress of the reaction may be monitored by measuring the melt viscosity or the monitoring the molecular weight of the polycarbonate in the reaction mixture using analysis methods well-known in the art such as gel permeation chromatography. These properties may be measured by taking discreet samples or may be measured on-line in commercial reactors or extruders. After the desired melt viscosity and/or molecular weight is reached, the final polycarbonate product may be isolated from the reactor in a solid or molten form. It will be appreciated by a person skilled in the art, that the method of making polycarbonates and co-polycarbonates as described in the preceding sections may be accomplished using a variety of melt reactor designs. In one embodiment, double or twin screw extruders equipped with one or more vacuum vents to remove volatiles may be used.

The polycarbonate resins of the present invention can be characterized by their molecular weight and their polydispersity (weight-averaged molecular weight divided by number-averaged molecular weight) properties, which can be measured using a gel permeation chromatography method well known to those skilled in the art. Any polycarbonate resin with a molecular weight sufficient to form a film is suitable for use in this invention. In one embodiment of the present invention, the polycarbonate resins have weight-averaged molecular weights in the range of 29,000 to 72,000 and with polydispersities in the range of 2.4 to 3.0. In another embodiment of the invention, the polycarbonate resins have molecular weights of 30,000 or less and with polydispersities in the range of less than 2.5 and greater than 2.0.

In the process of preparing the polycarbonate resins described herein, a branching reaction, known by those skilled in the art as a Fries reaction, can occur (especially at higher temperatures) resulting in chemical structures present along the polycarbonate resin chain commonly referred to by those skilled in the art as Fries products. Fries products are defined as structural units of the product polycarbonate which upon hydrolysis of the product polycarbonate affords a carboxy-substituted dihydroxy aromatic compound bearing a carboxy group adjacent to one or both of the hydroxy groups of said carboxy-substituted dihydroxy aromatic compound. For example, in bisphenol A polycarbonate prepared by a melt polymerization method in which Fries reaction occurs, the Fries product comprises structure (VII) below, which affords 2-carboxy bisphenol A upon complete hydrolysis of the product polycarbonate. As indicated, the Fries product may serve as a site for polymer branching, the wavy lines of structure (VII) indicating polymer chain structure.

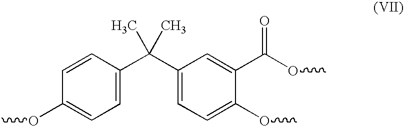

The polycarbonates prepared in the disclosed method are analyzed for Fries content by High Performance Liquid Chromatography (HPLC) and the concentration of Fries product is less than about 500 parts per million (ppm). This range of Fries concentration is much less than what is obtained in a conventional melt polymerization process. Fries products are generally considered undesirable, especially when present at high levels, because they can adversely affect the physical properties of the polycarbonate resin.

The activated carbonate process is often found to significantly reduce the amount of polycarbonate degradation products, including Fries products, and improve the color of polycarbonate resins as compared with polycarbonate resins made using a non-activated carbonate method.

Polycarbonates according to the present invention can also possess structural units indicative of the activated carbonate. These structural units may be end groups produced when activated carbonate fragments act as end capping agents or may be “kinks” introduced into the copolymer by incorporation of activated carbonate fragments. For example, the polycarbonates using ester-substituted diaryl carbonates may further comprise very low levels of structural features, which arise from side reactions taking place during the polymerization reaction between an ester-substituted diaryl carbonate of structure (IV) and a dihydroxy aromatic compound to form structure (VIII): 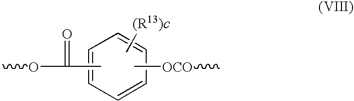
where R¹³ is a halogen atom, cyano group, nitro group, C₁-C₂₀ alkyl radical, C₄-C₂₀ cycloalkyl radical, C₄-C₂₀ aromatic radical, C₁-C₂₀ alkoxy radical, C₄-C₂₀ cycloalkoxy radical, C₄-C₂₀ aryloxy radical, C₁-C₂₀ alkylthio radical, C₄-C₂₀ cycloalkylthio radical, C₄-C₂₀ arylthio radical, C₁-C₂₀ alkylsulfinyl radical, C₄-C₂₀ cycloalkylsulfinyl radical, C₄-C₂₀ arylsulfinyl radical, C₁-C₂₀ alkylsulfonyl radical, C₄-C₂₀ cycloalkylsulfonyl radical, C₄-C₂₀ arylsulfonyl radical, C₁-C₂₀ alkoxycarbonyl radical, C₄-C₂₀ cycloalkoxycarbonyl radical, C₄-C₂₀ aryloxycarbonyl radical, C₂-C₆₀ alkylamino radical, C₆-C₆₀ cycloalkylamino radical, C₅-C₆₀ arylamino radical, C₁-C₄₀ alkylaminocarbonyl radical, C₄-C₄₀ cycloalkylaminocarbonyl radical, C₄-C₄₀ arylaminocarbonyl radical, or C₁-C₂₀ acylamino radical; and c is a whole number of 1-4. Typically such kinks are present only to a minor extent (for example, 0.2 to 1 mole %).

Another structural feature present in melt polymerization reactions between ester-substituted diaryl carbonates and dihydroxy aromatic compounds is the ester-linked terminal end group having structure (IX) where R¹³ and c are as defined above: 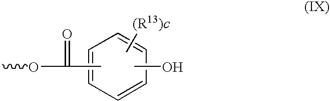
which possesses a free hydroxyl group. Without wishing to be bound by any theory, it is believed that structure (IX) may arise in the same manner as structure (VIII) but without further reaction of the ester-substituted phenolic hydroxy group. In the structures provided herein, the wavy line shown as [symbol]
represents the product polycarbonate polymer chain structure. End capping of the polymer chains made by this method may be only partial. In typical embodiments of copolycarbonates prepared by the methods described herein the free hydroxyl group content is from 7% to 50%. This number may be varied by changing reaction conditions or by adding additional endcapping agents. In one embodiment where the activated carbonate used is BMSC, there will be an ester linked end group of structure (X).

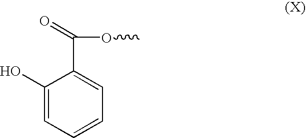

The polycarbonate made, using an activated aromatic carbonate as described above may also have end-groups having structure (XI) 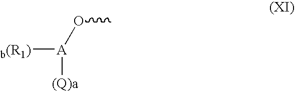
wherein Q is an ortho-positioned activating group. A is an aromatic ring, which can be the same or different depending on the number and location of their substituent groups, and a is a whole numbers of 1 up to a maximum equivalent to the number of replaceable hydrogen groups substituted on the aromatic rings A. R₁ is a substituent group selected from the group consisting of alkyl, cycloalkyl, alkoxy, aryl, alkylaryl, cyano, nitro, or halogen. The number b is a whole number of from zero up to a maximum equivalent to the number of replaceable hydrogen atoms on the aromatic ring A minus the number a. Non-limiting examples of suitable ortho-positioned activating groups Q include (alkoxycarbonyl)aryl groups, halogens, nitro groups, amide groups, sulfone groups, sulfoxide groups, or imine groups as described previously.

In one embodiment the terminal end group having structure (XII) is the methyl salicyl group of structure (XII) 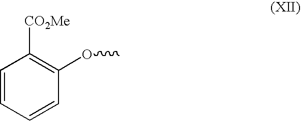
It could also include other salicyl groups such as the ethyl salicyl, isopropyl salicyl, and butyl salicyl groups.

In accordance with the film-casting process of the present invention, the polycarbonate is first dissolved in an inert organic solvent. Any inert organic solvent is suitable so long as the polycarbonate is sufficiently soluble in the solvent such that an undesirably large quantity of solvent is required. An inert organic solvent is any solvent that does not enter into reaction with the mixture components or adversely affects them. Examples of inert organic solvents include, but are not limited to methylene chloride, 1,2-dichloroethane, chlorobenzene, toluene, and combinations thereof. Typically, the solvent is methylene chloride. Commonly the solvent mixture contains a total weight of polycarbonate resin in a range between about 5 weight % to about 50 weight %, based on the total weight of the polycarbonate-solvent mixture. The viscosity of the polycarbonate-solvent mixture is typically at least about 10,000 centipoise. After evaporation, the residual solvent level is typically less than about 0.5 weight %, and more typically, less than about 0.01 weight %, based on the total weight of the polycarbonate-solvent mixture.

The polycarbonate resin used for making the polycarbonate solvent mixture can be in the form of a powder, a pellet or it can be in a granular form, which can be obtained from grinding the pellets or compressing the powder or by other methods known in the art for making granulated forms. A particular advantage of the melt process is that polycarbonate pellets can be obtained directly from the extruder or other types of melt reactors by chopping the cooled strands of the molten polycarbonate using strand pelletizing equipment known in the art. Polycarbonate pellets provide a convenient and efficient means of dissolving the polycarbonate resin into the organic solvent versus a powder which is often difficult to handle and can create a dust hazard. The polymer solution is typically filtered and a film of the solvent mixture is cast on to a polished surface such as a glass or metal polished surface. The solvent is slowly allowed to evaporate or is removed under reduced pressure by applying a vacuum. Heat can be applied to accelerate the solvent removal process. Industrially, the solvent mixture is often delivered to a coat hanger die that will uniformly spread the solution onto a continuous recirculating, highly polished metal belt. Typically, various drying conditions and methods are optimized to deliver film with a low residual solvent level. For example, the belt may be exposed to an initial drying step at a lower temperature and further subsequent drying step at a higher temperature, followed by stripping the film from the belt. These films generally have a thickness in a range between about 0.5 mil and about 25 mil, specifically in a range between about 1 mil and about 15 mil.

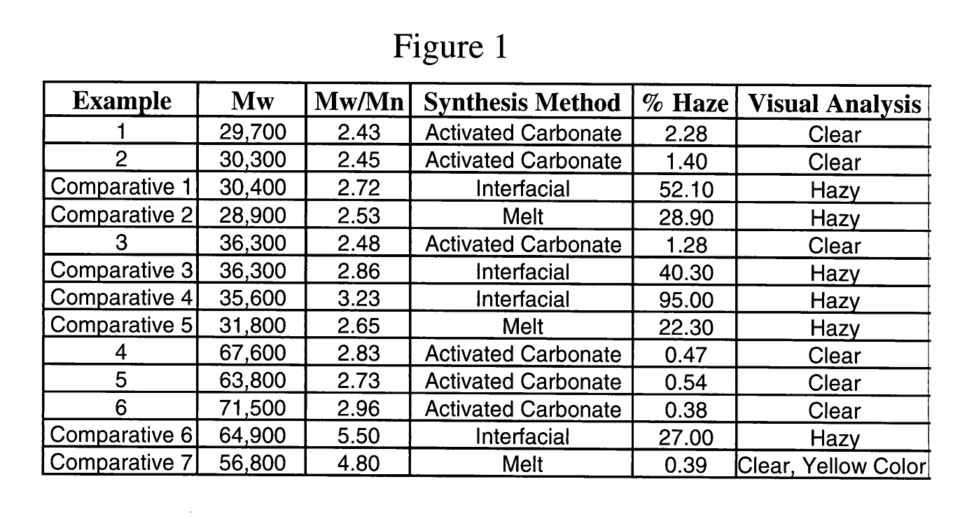

The % haze and visual analysis data listed in FIG. 1 show the benefits of forming films from polycarbonate resins made using the activated carbonate melt process. The haze percentage values for Examples 1-6 (from polycarbonate resins made using the activated carbonate melt process) were all below 3% indicating highly transparent films, while for the Comparative Examples 1-6 (from polycarbonate resins made using a non-activated carbonate melt process or an interfacial process) the haze percentage values are 22% or greater indicating translucent or opaque films. The haze percentage value for Comparative Example 7 (from a polycarbonate resin made using a non-activated melt process) was 0.39%, but the film quality was very poor. It was distinctly more yellow than any of the films produced from polycarbonate resins made using the activated carbonate process. The yellow color is indicative of polycarbonate resin degradation. Furthermore, a molecular weight analysis of the polycarbonate resin from Comparative Example 7 showed a very high molecular weight fraction indicating possible gels in the sample. The presence of a very high molecular weight fraction in the polycarbonate resin was not observed in any of the polycarbonate resins produced using the activated carbonate process. The yellow color of the film and the presence of gels in the film would be expected to significantly reduce the amount of light transmission through the film.

The films produced from the method of the present invention can be used, for example, in displays, in polymer light emitting diodes, in diffusers, in retardation films, in photovoltaics, in photoreceptor films, in photo-copier films and the like. The solvent casting process from the method of the present invention can also be used for producing thin film coatings on inorganic or organic substrates for photoresists, waveguides, arrayed waveguide gratings and the like for the microelectronics and optics industries.

The polycarbonates and methods of preparation disclosed here are further illustrated in of the following non-limiting examples.

### EXAMPLES

Molecular weights were determined by gel permeation chromatography analysis from resins dissolved in chloroform using polycarbonate standards.

For film casting, polymer solutions were made by dissolving 1.5 g of polymer in methylene chloride to a concentration of 10 wt % solids. Films were made by casting the 10 wt % solutions into standard 100 mm diameter glass Petri dishes. The dishes were subsequently completely covered with aluminum foil pans that had pinholes to allow the solvent to evaporate. The solvent was then allowed to evaporate overnight. The resulting films were nominally 0.13 mm thick

Transmission haze was measured with a hazemeter according to the ASTM D 1003 standardized test method.

### Examples 1 and 2

The samples were synthesized as follows. A stainless steel stirred tank reactor was charged with 30380.5 g BPA and 45056.4 g BMSC for a molar ratio of BMSC/BPA of 1.025. 2280 μl of an aqueous catalyst solution of tetramethylammonium hydroxide (TMAH) and sodium hydroxide (NaOH) was added to the reactor. The solution contained amounts corresponding, respectively, to 2.5×10−5 moles TMAH and 2.0×10−6 moles of NaOH per total number of moles of BPA. The reactor was then evacuated and purged with nitrogen three times to remove residual oxygen and then pressurized to a constant pressure of 1.5 bar of nitrogen. The reactor was then heated to 170° C. in order to melt and react the mixture. After approximately 5 hr 46 min from the start of heating, the molten reaction mixture was fed through a 170° C. heated feed-line into an extruder at a rate of 11.5 kg/h. The extruder was a Werner & Pfleiderer ZSK25WLE 25 mm 13-barrel twin-screw extruder with an L/D=59. The feed into the extruder comprised a flash-valve to prevent boiling of the molten mixture. The reaction mixture was reactively extruded at a 300 rpm screw speed. The extruder barrels were set to 300° C. and the die was set to 310° C. The extruder was equipped with five forward vacuum vents and one back-vent. For Example 1, the vacuum pressure of the back-vent was 13 mbar, and the vacuum pressure of the first forward vent was 4 mbar. For Example 2, the vacuum pressure of the back-vent was 14 mbar and the vacuum pressure of the first forward vent was 15 mbar. For both Examples, the vacuum pressure of the final four vents was less than 1 mbar. The methyl salicylate byproduct is removed via devolatilization through these vents. Collected at the end of the extruder through a die are molten strands of polymer that are solidified through a water bath and pelletized. The resulting product is a relatively colorless BPA polycarbonate. Example 1 was a sample collected approximately 55 min after the start of extrusion. Example 2 was a sample collected approximately 4 hr 42 min after the start of extrusion.

### Example 3

The sample was synthesized as in Example 1 with the following differences. The reactor tank was charged with 16858.4 g BPA and 25002.0 g BMSC for a molar ratio of BMSC/BPA of 1.025. 1250 μl of an aqueous catalyst solution of TMAH and NaOH was added to the reactor. The solution contained catalyst amounts corresponding, respectively, to 2.5×10⁻⁵ moles TMAH and 2.0×10⁻⁶ moles of NaOH per total number of moles of BPA. After purging, the reactor was held at a constant vacuum pressure of 800 mbar. After approximately 11 hr and 9 min from the start of heating (of the reactor tank), the reactor was pressurized with nitrogen to a constant pressure of 1.5 bar, and the molten reaction mixture was fed into the extruder at a rate of 12 kg/h. The vacuum pressure of the back-vent was 11 mbar. The vacuum pressure of the first forward vent was 2 mbar. The vacuum pressure of the final four forward vents was less than 1 mbar. The sample was collected approximately 2 hr 30 min after the start of extrusion.

### Example 4

The sample was synthesized as in Example 1 with the following differences. The reactor tank was charged with 20321.8 g BPA and 30308.8 g BMSC for a molar ratio of BMSC/BPA of 1.024. 1530 μl of an aqueous catalyst solution of TMAH and NaOH was also added to the reactor. The solution contained catalyst amounts corresponding, respectively, to 2.5×10⁻⁵ moles TMAH and 2.0×10⁻⁶ moles of NaOH per total number of moles of BPA. After approximately 5 hr from the start of heating (of the reactor tank) the molten reaction mixture was fed into the extruder at a rate of 12 kg/h. The vacuum pressure of the back-vent was 15 mbar. The vacuum pressure of the first forward vent was 5 mbar. The vacuum pressure of the final four forward vents was less than 1 mbar. Gradually BPA was added to the reactor tank until the molar ratio of BMSC/BPA reached 1.014. The sample was collected approximately 4 hr 6 min after the start of extrusion.

### Example 5

The sample was synthesized as in Example 1 with the following differences. The reactor tank was charged with 23761.0 g BPA and 35068.2 g BMSC for a molar ratio of BMSC/BPA of 1.020. 1780 μl of an aqueous catalyst solution of TMAH and NaOH was added to the reactor. The catalyst solution contained catalysts amounts corresponding, respectively, to 2.5×10⁻⁵ moles TMAH and 2.0×10⁻⁶ moles of NaOH per total number of moles of BPA. After purging, the reactor was held at a constant vacuum pressure of 800 mbar. After approximately 4 hr from the start of heating (of the reactor tank), the reactor was pressurized with nitrogen to a constant pressure of 1.5 bar, and the molten reaction mixture was fed into the extruder at a rate of 12 kg/h. The vacuum pressure of the back-vent was 14 mbar. The vacuum pressure of the first forward vent was 10 mbar. The vacuum pressure of the final four forward vents was less than 1 mbar. Gradually BPA was added to the reactor tank until the molar ratio of BMSC/BPA reached 1.014. The sample was collected approximately 2 hr 39 min after the start of extrusion.

### Example 6

The sample was synthesized as in Example 1 with the following differences. The reactor tank was charged with 23707.2 g BPA and 34919.1 g BMSC for a molar ratio of BMSC/BPA of 1.018. 1780 μl of an aqueous catalyst solution of TMAH and NaOH was also added to the reactor. The solution contained catalyst amounts corresponding, respectively, to 2.5×10⁻⁵ moles TMAH and 2.0×10⁻⁶ moles of NaOH per total number of moles of BPA. After purging, the reactor was held at a constant vacuum pressure of 800 mbar. After approximately 4 hr 8 min from the start of heating (of the reactor tank), the reactor was pressurized with nitrogen to a constant pressure of 1.5 bar, and the molten reaction mixture was fed into the extruder at a rate of 12 kg/h. The vacuum pressure of the back-vent was 12 mbar. The vacuum pressure of the first forward vent was 10 mbar. The vacuum pressure of the final four forward vents was less than 1 mbar. Gradually BPA was added to the reactor tank until the molar ratio of BMSC/BPA reached 1.014. The feed rate of the reaction mixture from the reactor tank into the extruder was reduced to 10 kg/h. The sample was collected approximately 3 hr 2 min after the start of extrusion.

### Comparative Examples 1 and 3

were obtained using commercially produced linear BPA polycarbonate resin powders available from GE Plastics (with commercial designations of PC 105 and PC 135). The polycarbonate resins were made using an interfacial process employing BPA and phosgene.

### Comparative Examples 2 and 5

were obtained using commercially produced BPA polycarbonate resin pellets available from GE Plastics (with commercial designations of 102× and 132×). The polycarbonate resins were made using a melt polymerization process employing BPA and diphenyl carbonate.

### Comparative Example 4

was obtaining using a commercially produced branched polycarbonate resin powder available from GE Plastics (with a commercial designation of PC 195). The polycarbonate resin was made using an interfacial process employing BPA, a branching agent, 1,1,1-trihydroxyphenylethane, and phosgene.

### Comparative Example 6

The following were added into a 500 mL 5-necked glass reactor: (a) BPA (50 g, 0.22 mol); (b) para-cumyl phenol (0.5 g, 0.0024 mol); (c) triethylamine (0.46 mL, 0.0032 mol); (d) methylene chloride (425 mL); and (e) de-ionized water (190 mL). Next phosgene (28.35 g, 2 g/min, 0.29 mol) was added to the reactor. During the addition of phosgene, base (25 wt % NaOH in deionized water) was simultaneously charged to the reactor to maintain the pH of the reaction between 9-11. After the complete addition of phosgene, the reactor was purged with nitrogen gas, and the organic layer comprising the methylene chloride was extracted. The organic extract was washed once with dilute hydrochloric acid (HCl), and subsequently washed with de-ionized water three times. The organic layer was separated and precipitated into vigorously stirred hot water. The polymer precipitate was dried in an oven at 110° C. before analysis.

### Comparative Example 7

The sample was synthesized as follows. A glass reactor was passivated by acid washing, rinsing with water and drying with nitrogen gas. 24.67 g BPA and 25.00 g DPC were also added into this reactor together with 100 μl of an aqueous catalyst solution. The aqueous catalyst solution contained TMAH and NaOH in amounts corresponding, respectively, to 2.5×10−4 moles TMAH and 7.5×10−6 moles of NaOH per total number of moles of BPA. The reactor was then evacuated and purged with nitrogen three times to remove residual oxygen. The melting and polymerization was carried out under nitrogen and the molten mixture was continuously stirred. The temperature-pressure profile used to carry out the melt polymerization comprised the following steps: (1) 15 min, 180° C., atmospheric pressure; (2) 60 min, 230° C., 170 mbar; (3) 30 min, 270° C., 20 mbar; (4) 60 min, 300° C., 0.5-1.5 mbar; (5) 30 min, 310° C., 0.5-1.5 mbar; (6) 50 min, 320° C., 0.5-1.5 mbar. During the melt polymerization, the phenol byproduct was removed from the reaction mixture by distillation. After the final step of the polymerization, the product polymer was recovered; the resulting product was a clear yellow BPA polycarbonate.

Film Results. Examples 1-6 listed in FIG. 1 and ranging in weight-averaged molecular weight from 29,700 (Example 1) to 71,500 (Example 6) were transparent with haze values less than 2.28% (Example 1) and as low as 0.38% (Example 6). In contrast, films formed from polycarbonates formed using an interfacial polymerization method, having similar weight-averaged molecular weight values of those formed using the activated-carbonate process of the present invention, were hazy with haze values ranging from 27% (Comparative Example 6) to 95% (Comparative Example 4). Films from polycarbonates formed using a melt process employing a non-activated carbonate process, were also hazy with haze values range values ranging from 22% (Comparative Example 5) to 29% (Comparative Example 2). In only one comparative example of a non-activated melt process was it possible to produce a low haze film (Comparative Example 7). However, this film had other issues that rendered it a poor quality film: The resin from Comparative Example 7 showed a very high molecular weight peak eluting at the elution limit of the gel permeation chromatography column, which was in addition to the main polycarbonate resin peak with the polydispersity of 4.8 and MW of 56,800. This very high molecular weight peak is likely indicative of the presence of gels in the resin, which is very undesirable in the production of high quality films. The film made from Comparative Example 7 also had a yellow color, which likely indicates the presence of polycarbonate degradation products that are also undesirable for the production of high quality films.

While the invention has been described with the reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling with the scope of the appended claims.

1. A method for making solvent cast films comprising the steps of making and isolating a polycarbonate resin using an activated carbonate melt process; forming a mixture comprising said polycarbonate resin and a solvent; and casting a polycarbonate film from said mixture.

2. The method according to claim 1, wherein the polycarbonate resin comprises bisphenol-A polycarbonate resin.

3. The method according to claim 1, wherein the activated carbonate melt process is conducted in an extruder.

4. The method according to claim 3, wherein the activated carbonate melt process comprises bis(o-methylsalicyl)carbonate.

5. The method according to claim 1, wherein the solvent is methylene chloride.

6. The method according to claim 1, wherein the polycarbonate resin has a weight-averaged molecular weight of between 72,000 and 29,000 as measured by gel permeation chromatography using polycarbonate standards.

7. The method according to claim 1, wherein the polycarbonate resin has a weight-averaged molecular weight of less than 31,000 and a polydispersity of less than 2.4 and greater than 2.0 as measured by gel permeation chromatography using polycarbonate standards.

8. The method according to claim 1; wherein the polycarbonate resin has a weight-averaged molecular weight between 72,000 and 29,000 and a polydispersity between 2.4 and 3.0 as measured by gel permeation chromatography using polycarbonate standards.

9. The method according to claim 1, wherein the polycarbonate resin is pelletized prior to the step of forming the mixture. The mixture comprising said polycarbonate resin and the solvent.

10. A polycarbonate film made by the method of claim 1.

11. The polycarbonate film of claim 7, wherein the polycarbonate film has a haze of less than 3% as measured using a hazemeter according to ASTM D1003 testing method.

12. The polycarbonate film of claim 7, wherein the polycarbonate film has a haze of less than 1% as measured using a hazemeter according to ASTM D1003 testing method.

13. A capacitor film prepared by the method of claim 1.

14. A photoreceptor film prepared by the method of claim 1.

15. A film coating on an organic or inorganic substrate prepared by the method of claim 1.

16. A photoresist, a waveguide or an arrayed waveguide grating made from the method of claim 14.
